(19) United States
(12) Patent Application Publication
(10) Pub. No.: US 2022/0136543 A1
(43) Pub. Date: May 5, 2022

(54) QUICK-CHANGE SURFACE PANEL

(71) Applicant: GALLOP BRUSH LLC, IMLAY CITY, MI (US)

(72) Inventors: THEODORE YAMIN, SR., METAMORA, MI (US); ANTHONY ROBERT SPEARING, METAMORA, MI (US)

(73) Assignee: GALLOP BRUSH LLC, IMLAY CITY, MI (US)

(21) Appl. No.: 17/086,581

(22) Filed: Nov. 2, 2020

(51) Int. Cl. F16B 5/06; B60S 3/06

(52) U.S. Cl. CPC F16B 5/0621; B60S 3/06

(57) ABSTRACT

A quick-change surface panel for a carwash, and a system for using a quick-change surface panel for a carwash are disclosed. The surface panel is an annular piece of flexible hygroscopic material. The surface panel is partitioned from its outer diameter inward towards the inner diameter, creating a plurality of radially-arranged wash elements. The radially-arranged wash elements terminate at a common center. A two-piece collar attaches each quick-change surface panel to a rotational hub. A spacer is positioned between each quick-change surface panel.

### FIELD OF INVENTION

The present invention relates to the classification for Servicing, Cleaning, Repairing, Supporting, Lifting, or Maneuvering of Vehicles Not Otherwise Provided for; and to one or more sub-classifications for Vehicle cleaning apparatus not integral with vehicles, for exteriors of land vehicles, with rotary bodies contacting the vehicles. Specifically, the present invention is quick-change surface panel that allows for rapid maintenance of the surface panel rotary brush that form a core part of a carwash.

### BACKGROUND OF INVENTION

Modern carwashes deploy a plurality of rotary brushes to remove dirt and debris from the exterior of motor vehicles. Rotary brushes can be constructed in a couple of different manners. One type rotary brush is constructed from a plurality of surface panels, or surface panels, which are comprised of a single annular piece of flexible hygroscopic material that is attached to a core at its center. The single annular piece is a surface, hence the nickname surf panel. The surface panel can be partially, radially partitioned or cut from the outer perimeter of the annulus. This creates a plurality of free ends all attached at a common center.

The repetitive contact of the free ends of the surface panels degrades the integrity of the material from which they are fabricated. The panels often tear. When a rotary brush loses part of one or more surface panels, it rotates out of balance. Although a rotary brush assembly is designed to handle out-of-balance rotary brushes, the long-term effect is negative. Proper maintenance requires the replacement of the surface panels at pre-defined intervals. Damage, such as tears, to the surface panels also requires maintenance.

The maintenance of rotary brush assemblies can be time-consuming and costly. If maintenance is required during operational hours for the car wash, it results in down-time during which employees are being paid, but no vehicles are being washed. If maintenance is performed during non-operational hours, staff must either be present before or after operational hours to perform the maintenance.

Most rotary brush assemblies are cumbersome with respect to replacing or re-positioning the surface panels. What the market needs is a rotary brush assembly that allows for the quick replacement or re-positioning of the surface panels.

### SUMMARY OF THE INVENTION

This summary is intended to disclose the present invention, a quick-change surface panel used on a rotary brush typically found in carwashes. The embodiment and description are used to illustrate the invention and its utility and are not intended to limit the invention or its use. The following presents a simplified summary of the primary embodiment of the invention to provide a basic understanding of the invention. Additional concepts that can be added or varied with the primary embodiment are also disclosed. The present invention is novel with respect to the prior art, and can be distinguished from the prior art.

In general, the present invention, a quick-change surface panel used allows for rapid maintenance of the surface panels on rotary brushes typically found in car washes. The quick-change surface panel is comprised of a surface panel and a two-piece collar that interfaces with a rotational hub. The quick-change surface panel which is the subject of this patent is used in conjunction with a surface panel assembly. The surface panel assembly is comprised of a plurality of surface panels, a two-piece collar for each surface panel, a spacer between each pair of surface panels, and a rotational hub.

The surface panel is annular and planar. The surface panel has an outer diameter; an inner diameter; a plurality of cuts or partitions extending from the outer diameter inward, making a plurality of radially arranged wash elements; and a common center.

The two-piece collar has an upper piece and a lower piece. The upper piece and lower piece are identical. Each piece of the two-piece collar has a flat surface and a mating surface. Both the flat surface and the mating surface are generally planar and annular. The mating surface has a plurality of mating holes and tangs. The mating holes extend through each piece of the two-piece collar, from the mating surface to the flat surface. The mating surface of an upper piece is aligned oppositionally with the mating surface of a lower piece so that the tangs in the upper piece align with the mating holes in the lower piece; and so the tangs in the lower piece align with the mating holes in the upper piece.

The two-piece collar is positioned over the inner diameter of the surface panel. The surface panel has cut-outs distributed evenly about its inner diameter, which allow the tangs to pass through the surface panel. The two-piece collar is snapped together, with the tangs extending through the surface panel. The inner diameter of two-piece collar has a plurality of protrusions about its inner diameter.

FIG. 4 is a view of the lower piece 60B of the two-piece collar 60. The lower piece 60B and the upper piece 60A are identical. In this view, the mating surface 65 of the lower piece 60B is visible. In use, the mating surface 65 of the lower piece 60B is arranged oppositionally with the mating surface 65 of the upper piece 60A. The mating surface 65 is annular and generally flat, with a plurality of protrusions 67 along the inner diameter 66, 68. The mating surface 65 has an outer diameter 61, and an inner diameter 66, 68. The lower piece 60B has a plurality of mating tangs 64, and an equal plurality of mating holes 63.

As shown in FIG. 6B, the lower piece 60B and the upper piece 60A are affixed to the surface panel 50 near its inner diameter 59.

As shown in FIG. 3, the surface panel 50 is affixed to the two-piece collar 60 The two-piece collar 60 fits snuggly about a rotational hub 2. The rotational hub 2 has a plurality of indentations 21 about its outer diameter 22. The plurality of indentations 21 mate with the plurality of protrusions 68 of the inner diameter 66 of the two-piece collar 60. The outer diameter 22 of the rotational hub 2 fits snuggly with the inner diameter 66 of the two-piece collar 60.

FIG. 5 shows the surface panel 50 with one-piece 60B of the two-piece collar 60 located underneath and partially visible. The surface panel 50 is annular and planar.

FIG. 2 shows a spacer 40. The spacer 40 has a top surface 41, an outer diameter 42, and an inner diameter 43. The inner diameter 41 of the spacer 40 has a plurality of protrusions 44. The plurality of protrusions 44 of the spacer 40 align and mate snuggly with the plurality of indentations 21 of the rotational hub 2. The inner diameter 43 of the spacer 40 fits snuggly over the outer diameter 22 of the rotational hub 2, when the plurality of protrusions 44 of the spacer 40 are aligned with the plurality of indentations 21 of the rotational hub 2.

FIG. 1 shows a surface panel 50, a two-piece collar 60, a spacer 40, and a rotational hub 2. The surface panel 50 has the following elements visible in this view: an outer diameter 52, a plurality of cuts or partitions 53 making a plurality of radially-arranged wash elements 51, and a common center 54. The radially-arranged wash elements 51 are all connected to the common center 54. The rotational hub 2 has the following elements visible in this view: an outer diameter 22, a plurality of indentations 21, and a plurality of axial through-holes 20.

The spacer 40 slips on and off the rotational hub 2. The surface panel 50 with the two-piece collar 60 affixed also slips on and off the rotational hub 2. The rotational hub 2 is connected to a rotary brush assembly with the through-holes 20.

During maintenance of a rotary brush employing surface panels the rotational hub 2 is removed from the rotary brush assembly. Then the old surface panels 50 are removed by removing the spacer and the surface panel 50. A new surface panel 50 is put into place by placing the two-piece collar 60 over the rotational hub 2. A spacer 40 is placed between every pair of surface panels 50.

The surface panel is fabricated from a flexible and durable hygroscopic material, such as felt, foamed polymers, polyethylene, foamed EVA, or fabric.

The rotational hub is fabricated from a durable metal suitable to the application, such as steel, aluminum, an alloy of steel, or an alloy of aluminum. The rotational hub is most easily fabricated using a computer, numerically controlled machine (“CNC”).

The two-piece collar is fabricated from a polymer such as polyvinyl chloride (“PVC”), polypropylene (“PP”), acrylonitrile butadiene styrene (“ABS”), nylon, high-density polyethylene (“HDPE”), low-density polyethylene (“LDPE”), and polyethylene terephthalate (“PET”).

The spacer is fabricated from a polymer such as PVC, PP, ABS, nylon, HDPE, LDPE, or PET. The spacer can also be fabricated from steel, aluminum, magnesium, or zinc, or an alloy of one or more of the foregoing metals.

### BRIEF DESCRIPTION OF THE DRAWINGS

The present invention is illustrated with 6 drawings on 7 sheets.

FIG. 1 is a top perspective view of a surface panel, a two-piece collar, a spacer, and a rotational hub.

FIG. 2 is a top perspective view of a spacer.

FIG. 3 is a top perspective view of a surface panel, a two-piece collar, and a rotational hub.

FIG. 4 is a top perspective view of one half of a two-piece collar.

FIG. 5 is a top perspective view of a surface panel with one half of the two-piece collar adhered to it.

FIG. 6A is a top perspective view of a surface panel with the two-piece collar adhered to it.

FIG. 6B is an isolation of the interface of the surface panel with the two-piece collar.

### DETAILED DESCRIPTION OF THE DRAWINGS

The following descriptions are not meant to limit the invention, but rather to add to the summary of invention, and illustrate the present invention, quick-change surface panel. The present invention is illustrated with a variety of drawings showing the primary embodiment of the present invention, with examples presented of the various form-factors that the present invention can take.

Certain terminology is used in the following description for convenience only and is not limiting. The article “a” is intended to include one or more items, and where only one item is intended the term “one” or similar language is used. Additionally, to assist in the description of the present invention, words such as top, bottom, side, upper, lower, front, rear, inner, outer, right and left are used to describe the accompanying figures. The terminology includes the words above specifically mentioned, derivatives thereof, and words of similar import.

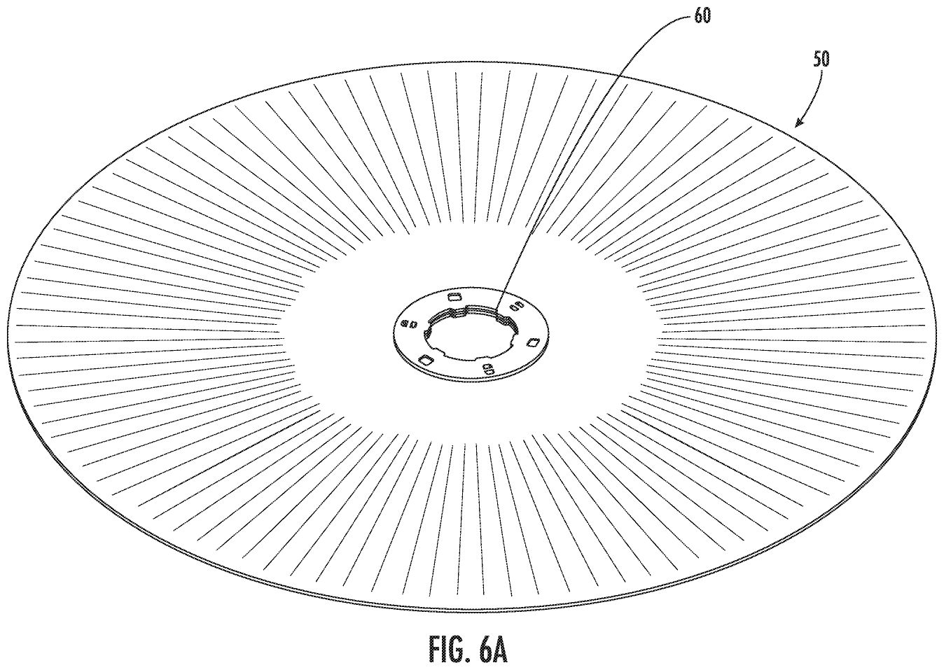

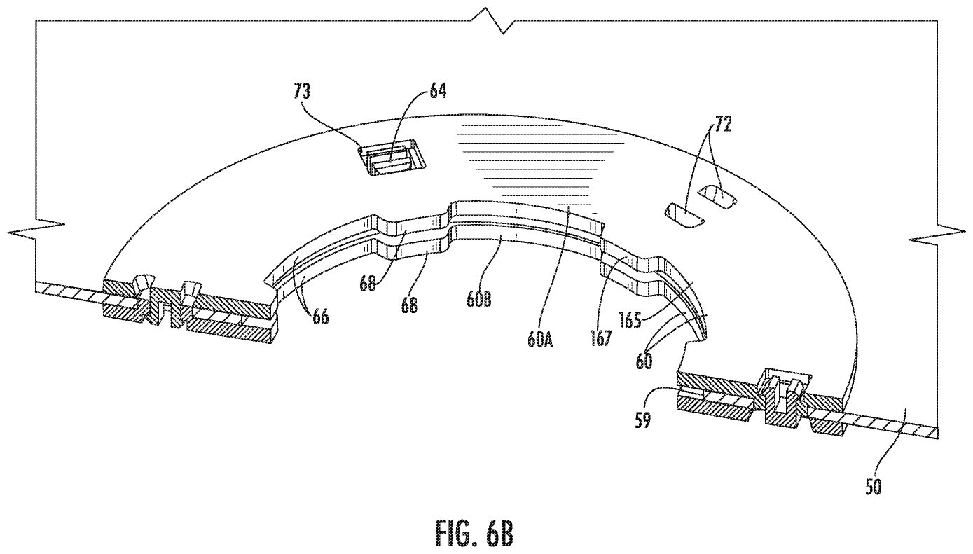

FIG. 6A shows a surface panel 50 and a two-piece collar 60. FIG. 6B is an isolation, showing how a two-piece collar 60 is affixed to the surface panel 50. The two-piece collar 60 has an upper piece 60A and a lower piece 60B. The upper piece 60A is prominent in FIG. 6B. The flat surface 165, 167 of the upper piece 60A is discernible. A mating hole 73 and mating tang 64 are visible on the flat surface 165. A molding feature 72, representing the back-side of a mating tang 64 is also visible. There are protrusions 167 on the flat surface 165. On the inner diameter 66, 68, the upper piece 60A and the lower piece 60B are identical. The inner diameter 66 has a plurality of protrusions 68.

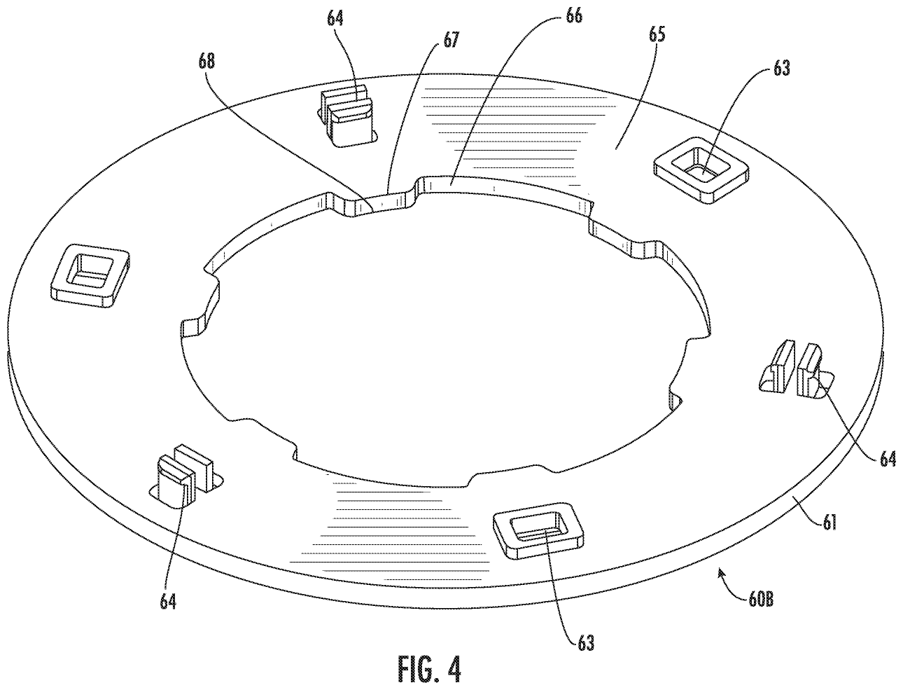

FIG. 4 is a view of the lower piece 60B of the two-piece collar 60. The lower piece 60B and the upper piece 60A are identical. In this view, the mating surface 65 of the lower piece 60B is visible. In use, the mating surface 65 of the lower piece 60B is arranged oppositionally with the mating surface 65 of the upper piece 60A. The mating surface 65 is annular and generally flat, with a plurality of protrusions 67 along the inner diameter 66, 68. The mating surface 65 has an outer diameter 61, and an inner diameter 66, 68. The lower piece 60B has a plurality of mating tangs 64, and an equal plurality of mating holes 63.

As shown in FIG. 6B, the lower piece 60B and the upper piece 60A are affixed to the surface panel 50 near its inner diameter 59.

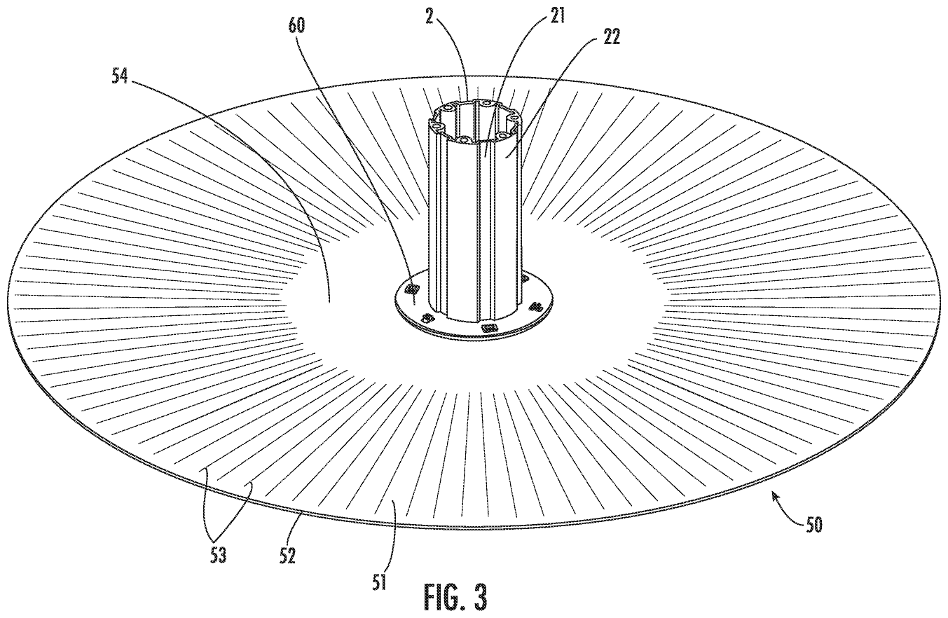

As shown in FIG. 3, the surface panel 50 is affixed to the two-piece collar 60. The surface panel 50 has an outer diameter 52, a plurality of cuts or partitions 53 making a plurality of wash elements 51, and a common center 54. The two-piece collar 60 fits snuggly about a rotational hub 2. The rotational hub 2 has a plurality of indentations 21 about its outer diameter 22. The plurality of indentations 21 mate with the plurality of protrusions 68 of the inner diameter 66 of the two-piece collar 60. The outer diameter 22 of the rotational hub 2 fits snuggly with the inner diameter 66 of the two-piece collar 60.

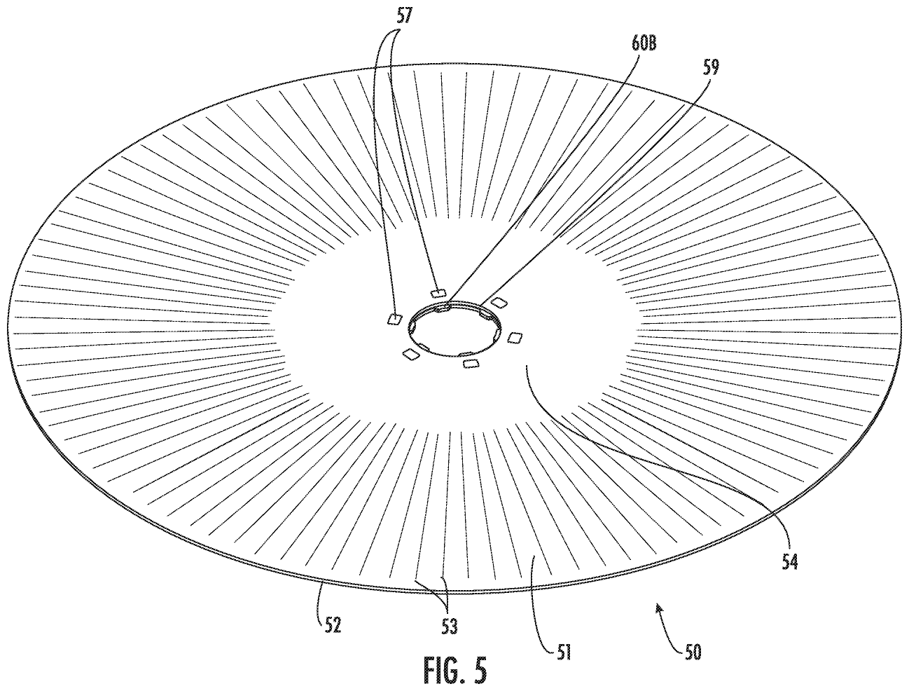

FIG. 5 shows the surface panel 50 with one-piece 60B of the two-piece collar 60 located underneath and partially visible. The surface panel 50 is annular and planar.

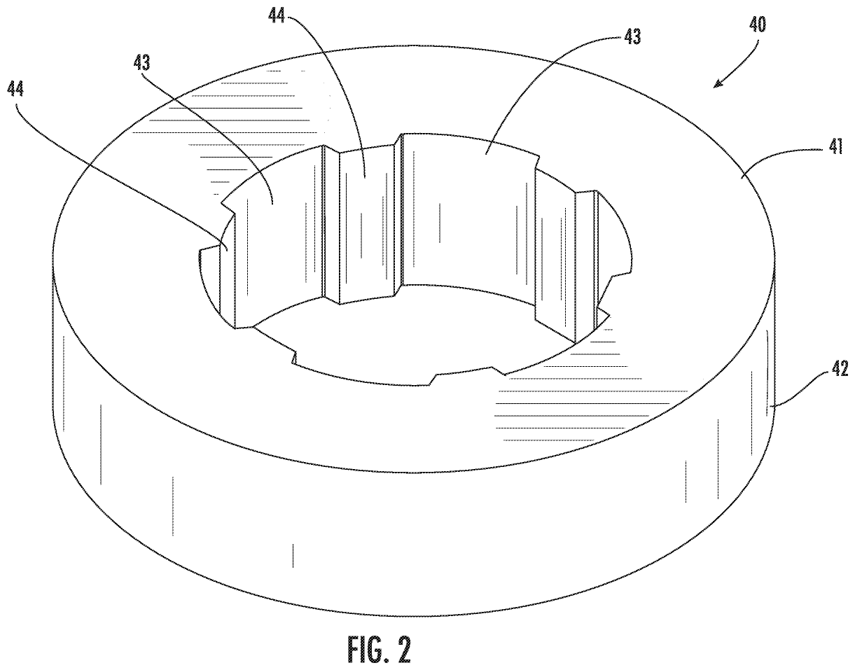

FIG. 2 shows a spacer 40. The spacer 40 has a top surface 41, an outer diameter 42, and an inner diameter 43. The inner diameter 41 of the spacer 40 has a plurality of protrusions 44. The plurality of protrusions 44 of the spacer 40 align and mate snuggly with the plurality of indentations 21 of the rotational hub 2. The inner diameter 43 of the spacer 40 fits snuggly over the outer diameter 22 of the rotational hub 2, when the plurality of protrusions 44 of the spacer 40 are aligned with the plurality of indentations 21 of the rotational hub 2.

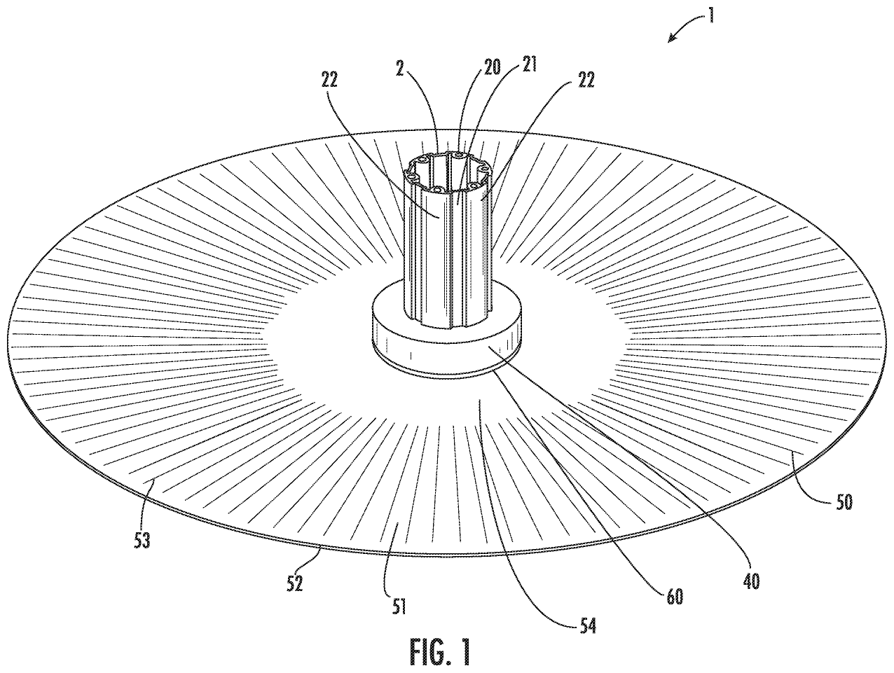

FIG. 1 shows a surface panel 50, a two-piece collar 60, a spacer 40, and a rotational hub 2. The surface panel 50 has the following elements visible in this view: an outer diameter 52, a plurality of cuts or partitions 53 making a plurality of wash elements 51, and a common center 54. The rotational hub 2 has the following elements visible in this view: an outer diameter 22, a plurality of indentations 21, and a plurality of axial through-holes 20.

The spacer 40 slips on and off the rotational hub 2. The surface panel 50 with the two-piece collar 60 affixed also slips on and off the rotational hub 2. The rotational hub 2 is connected to a rotary brush assembly with the through-holes 20.

A system can be constructed using a plurality of identical surface panels 50, each with a two-piece collar 60 affixed about the inner diameter as described herein. The plurality of surface panels 50 are separated from one another by a spacer 40. The plurality of surface panels 50 with affixed two-piece collars 60, and the plurality of spacers 40, mate with the rotational hub 2. The rotational hub 2 has a plurality of indentations 21 about its outer diameter 22. Each two-piece collar 60 has an equal plurality of protrusions 68 about its inner diameter 66. Each spacer 40 has a plurality of protrusions 44 equal in number to the plurality of indentation 21 on the rotational hub 2.

During maintenance of a rotary brush employing surface panels the rotational hub 2 is removed from the rotary brush assembly. Then the old surface panels 50 are removed by removing the spacer and the surface panel 50. A new surface panel 50 is put into place by placing the two-piece collar 60 over the rotational hub 2. A spacer 40 is placed between every pair of surface panels 50.

We claim:

1. A quick-change surface panel comprising
an annular surface panel having an outer diameter, an inner diameter, a common center, and a plurality of cut-outs arranged radially about the inner diameter;
a two-piece collar comprised of two identical annular pieces, one denominated the upper piece and one denominated the lower piece;
wherein the upper piece and the lower piece each have a mating surface and a flat surface;
wherein each mating surface has a plurality of tangs and mating holes;
wherein a plurality of partitions are made from the outer diameter of the annular surface panel towards the inner diameter of the annular surface panel, terminating at the common center, and creating a plurality of radially-arranged wash elements; and
wherein the mating surfaces of the upper piece and the lower piece are disposed oppositionally to one another, with the inner diameter of the annular surface panel positioned between them, so that the tangs in the lower piece pass through the cut-outs of the annular surface panel and align with the mating holes of the upper piece and the tangs in the upper piece pass through the cut-outs of the annular surface panel and align with the mating holes of the lower piece.

2. The quick-change surface panel of claim 1, wherein the tangs of the upper piece snap-fit into the mating holes of the lower piece; and wherein the tangs in the lower piece snap-fit into the mating holes of the upper piece.

3. The quick-change surface panel of claim 2, where each of the upper piece and the lower piece have a plurality of protrusions about their inner diameters.

4. The quick-change surface panel of claim 3, wherein the annular surface panel is constructed from piece of flexible hygroscopic material.

5. The quick-change surface panel of claim 4, wherein the flexible hygroscopic material is one of felt, foamed polymers, polyethylene, foamed EVA, or fabric.

6. The quick-change surface panel of claim 5, wherein the two-piece collar is constructed from one of polyvinyl chloride (“PVC”), polypropylene (“PP”), acrylonitrile butadiene styrene (“ABS”), nylon, high-density polyethylene (“HDPE”), low-density polyethylene (“LDPE”), and polyethylene terephthalate (“PET”).

7. A quick-change surface panel system comprising
a plurality of annular surface panels, each annular surface panel having an outer diameter, an inner diameter, a common center, and a plurality of cut-outs arranged radially about its inner diameter;
a plurality of two-piece collar, equal in number to the plurality of annular surface panels, each two-piece collar being comprised of two identical annular pieces, one denominated the upper piece and one denominated the lower piece;
a rotational hub having an outer diameter; and
a plurality of spacers having an inner diameter;
wherein each annular surface panel has affixed about its inner diameter a two-piece collar;
wherein, between each pair of annular surface panels is a spacer; and
wherein each two-piece collar and each spacer slides onto the rotational hub and mates snuggly.

8. The quick-change surface panel system of claim 7, wherein each annular surface panel contains a plurality of partitions from the outer diameter of the annular surface panel towards the inner diameter of the annular surface panel, terminating at the common center, and creating a plurality of radially-arranged wash elements

9. The quick-change surface panel system of claim 8, wherein, for each two-piece collar, the upper piece and the lower piece each have a mating surface and a flat surface.

10. The quick-change surface panel system of claim 9, wherein for each two-piece collar, the mating surface of both the upper piece and the lower piece has a plurality of tangs and mating holes.

11. The quick-change surface panel system of claim 10, wherein for each two-piece collar, the mating surfaces of the upper piece and each lower piece are disposed oppositionally to one another, with the inner diameter of their respective annular surface panel positioned between them, so that the tangs in the lower piece pass through the cut-outs of the annular surface panel and align with the mating holes of the upper piece and the tangs in the upper piece pass through the cut-outs of the surface panel and align with the mating holes of the lower piece.

12. The quick-change surface panel system of claim 11, wherein for each two-piece collar, the tangs of the upper piece snap-fit into the mating holes of the lower piece; and wherein the tangs in the lower piece snap-fit into the mating holes of the upper piece.

13. The quick-change surface panel system of claim 12, wherein for each two-piece collar, both the upper piece and the lower piece have a plurality of protrusions about their inner diameters.

14. The quick-change surface panel system of claim 13, wherein the outer diameter of the rotational hub has a plurality of indentations, equal in number to the plurality of protrusions on the inner diameter of each two-piece collar.

15. The quick-change surface panel system of claim 14, wherein the plurality of indentations in the rotational hub mate snuggly with the protrusions in the inner diameter of each two-piece collar.

16. The quick-change surface panel of claim 15, wherein each spacer has a plurality of protrusions on its inner diameter equal in number to the plurality of protrusions on each two-piece collar.

17. The quick-change surface panel system of claim 16, wherein the plurality of indentations in the rotational hub mate snuggly with the protrusions in the inner diameter of each two-piece spacer.

18. The quick-change surface panel system of claim 17, wherein each annular surface panel is constructed from a piece of flexible hygroscopic material.

19. The quick-change surface panel system of claim 18 wherein the flexible hygroscopic material is one of felt, foamed polymers, polyethylene, foamed EVA, or fabric.

20. The quick-change surface panel system of claim 19, wherein the rotational hub is fabricated from one of steel, aluminum, an alloy of steel, and an alloy of aluminum.
